(19) United States
(12) Patent Application Publication
(10) Pub. No.: US 2006/0176222 A1
(43) Pub. Date: Aug. 10, 2006

(54) Apparatus for aligning an irregular shaped head with a cavity during insertion

(75) Inventors: Oyeneye O. Coker, Miami, FL (US); Donald W. Burnette, Sunrise, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/054,684

(22) Filed: Feb. 9, 2005

(51) Int. Cl. H01Q 1/24

(52) U.S. Cl. 343/702; 343/906; 343/895

(57) ABSTRACT

An apparatus (200) has an irregular shaped head (202) coupled to a top end (203) of a stem (206), a protrusion (208) coupled to a side surface (207) of the stem, and a housing assembly (204). The housing assembly comprises a conduit (209) for insertion and extraction of the stem, a cavity (222) above the conduit, wherein the cavity is shaped according to the irregular shaped head for engaging therewith, and a guiding element (212A-C) coupled to the conduit to rotationally guide the protrusion so that the irregular shaped head aligns with the cavity during insertion.

### FIELD OF THE INVENTION

This invention relates generally to an apparatus with an alignment function, and more particularly to an apparatus for aligning an irregular shaped head with a cavity during insertion.

### BACKGROUND OF THE INVENTION

Devices with extractable portions, such as an antenna of a cellular phone, can suffer damage during insertion. This is particularly evident when there is only a single way to insert an irregular shaped head of the antenna in a corresponding cavity without damage. A user's repeated attempts at inserting the irregular shaped head into the corresponding cavity without additional guidance can cause undue friction and wear on such components.

### SUMMARY OF THE INVENTION

Embodiments in accordance with the invention provide an apparatus for aligning an irregular shaped head with a cavity during insertion.

In a first embodiment of the present invention, an apparatus has an irregular shaped head coupled to a top end of a stem, a nipple coupled to a side surface of the stem, and a housing assembly. The housing assembly comprises a conduit for insertion and extraction of the stem, a cavity above the conduit, wherein the cavity is shaped according to the irregular shaped head for engaging therewith, and a slide coupled to the conduit to rotationally guide the nipple so that the irregular shaped head aligns with the cavity during insertion.

In a second embodiment of the present invention, a selective call radio (SCR) has an antenna comprising an irregular shaped head coupled to a top end of a stem having a nipple coupled to a side surface of the stem, a receiver coupled to the antenna, a processor coupled to the receiver, and a housing assembly. The housing assembly comprises a conduit for insertion and extraction of the stem, a cavity above the conduit, wherein the cavity is shaped according to the irregular shaped head for engaging therewith, and a slide coupled to the conduit to rotationally guide the nipple so that the irregular shaped head aligns with the cavity during insertion.

In a third embodiment of the present invention, an apparatus has an irregular shaped head coupled to a top end of a stem, a protrusion coupled to a side surface of the stem, and a housing assembly. The housing assembly comprises a conduit for insertion and extraction of the stem, a cavity above the conduit, wherein the cavity is shaped according to the irregular shaped head for engaging therewith, and a guiding element coupled to the conduit to rotationally guide the protrusion of the stem so that the irregular shaped head aligns with the cavity during insertion.

### BRIEF DESCRIPTION OF THE DRAWINGS

FIG. 1 is a block diagram of a selective call radio (SCR) in accordance with an embodiment of the present invention.

FIGS. 2-6 are illustrations of a housing assembly of the SCR for carrying an antenna with an irregular shaped head in accordance with an embodiment of the present invention.

### DETAILED DESCRIPTION

While the specification concludes with claims defining the features of embodiments of the invention that are regarded as novel, it is believed that the embodiments of the invention will be better understood from a consideration of the following description in conjunction with the figures, in which like reference numerals are carried forward.

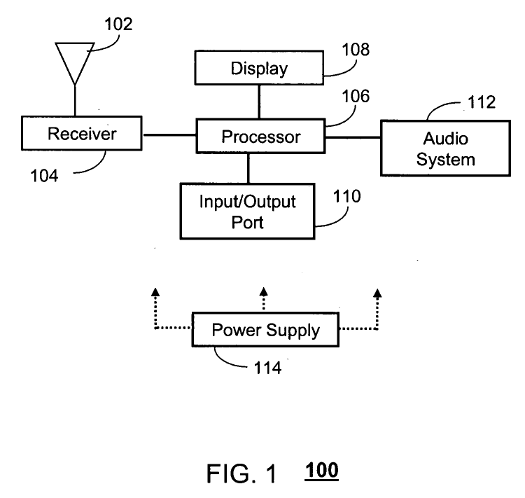

FIG. 1 is a block diagram of an SCR 100 in accordance with an embodiment of the present invention. The SCR 100 comprises conventional electrical components such as an antenna 102, a receiver 104 coupled to the antenna 102, and a processor 106 coupled to the receiver 104. The SCR 100 can further include the following conventional components: a display 108 for displaying a UI (User Interface) and/or graphics to an end user of the SCR 100, an input/output port 110 for coupling to a keypad for directing functions of the processor 106, or coupling to accessories and/or other devices extending the function of the SCR 100, an audio system 112 for presenting audible signals such as music and alerts to the end user of the SCR 100, and a power supply 114 for supplying power to the components of the SCR 100.

The processor 106 utilizes conventional means such as a microprocessor, memory and software applications operating therein for controlling operations of the foregoing components 102-114 of the SCR 100. The receiver 104 is a conventional receiver for receiving radio messages from a communication network. Although not shown in FIG. 1, the SCR 100 can further include a transmitter. In this embodiment, the SCR 100 can be used as a wireless two-way communication device such as a cell phone.

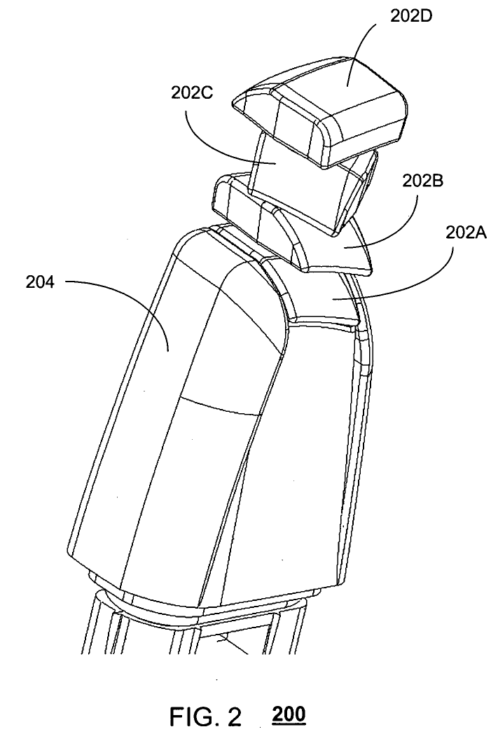

The foregoing electrical components 102-114 of the SCR 100 are contained in a housing assembly using conventional materials such as plastics, metal, and/or other commonly used compounds. Portions 200 of this housing assembly are shown in FIGS. 2-6 in accordance with an embodiment of the present invention. The portions of the housing assembly not shown in FIGS. 2-6 include, for example, conventional components used in most SCRs 100 such as a flip housing portion for carrying the display 108 and a headset coupled to the audio system 112 for listening to voice messages, and a base housing portion for carrying a keypad coupled to the input/output port 110 and a microphone coupled to the audio system 112 for conveying voice messages.

Rear housing elements can also be included with these portions. For example, the flip portion can include a second component of the display 108 for presenting, for example, caller ID information, clock and date, or other pertinent information to an end user of the SCR 100. The base housing portion can include a rear battery door for carrying a battery coupled to the power supply 114, and a housing assembly 204 such as shown in FIGS. 2-6 for carrying the antenna 102.

In the illustration of FIG. 2, an antenna 200 has an irregular shaped head 202 in accordance with an embodiment of the present invention. (In the context herein, an irregular shaped head typically includes a non-symmetrical head, but the scope of the invention herein and the interpretation of “irregular” should be understood to apply to any head that fits into a mating receptacle in a limited number of positions whether it is symmetrical or not. A “regular” head can fit into a mating receptacle universally in practically an unlimited number of positions by rotating the head.) As shown in FIG. 2, when an end user of the SCR 100 extracts the antenna 102 from the housing assembly 204 the end user may rotate the antenna 102 by 360 degrees from its home position 202A. Three exemplary rotations are shown in FIG. 2: zero degrees rotation 202A-202B, fifty degrees rotation 202C, and one hundred eighty degrees rotation 202D.

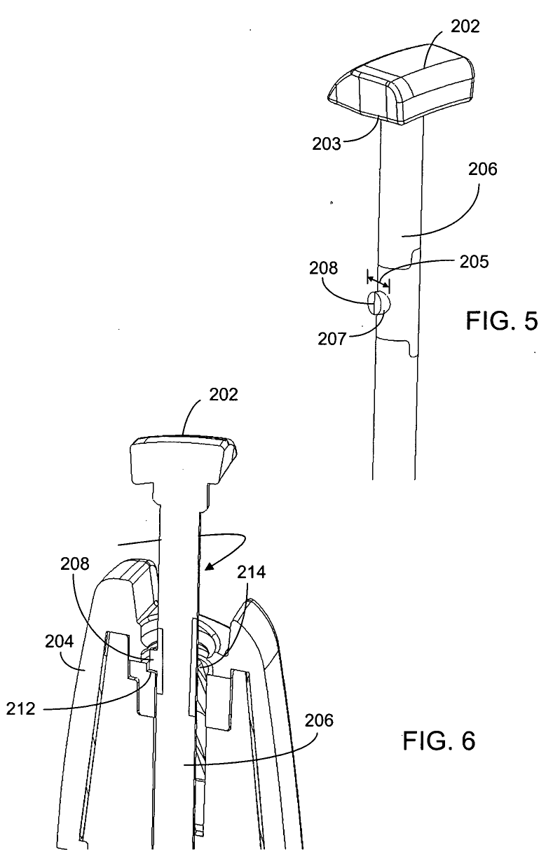

As shown in FIG. 5, the irregular shaped head of the antenna 202 is coupled to a top end 203 of a stem 206 having a protrusion 208 coupled to a side surface 207 of the stem 206. The protrusion 208 can be a nipple (herein referred to as nipple 208) as shown in FIG. 5. It will be appreciated that other forms of a protrusion 208 can be used within the scope and spirit of the claims described herein. The stem 206 in turn is electrically coupled to an electrical circuit of the receiver 104 (not shown) for processing radio signals at the receiver 104. Where a transmitter is also available, the stem 206 is also coupled to said transmitter for radiating signals generated by the transmitter.

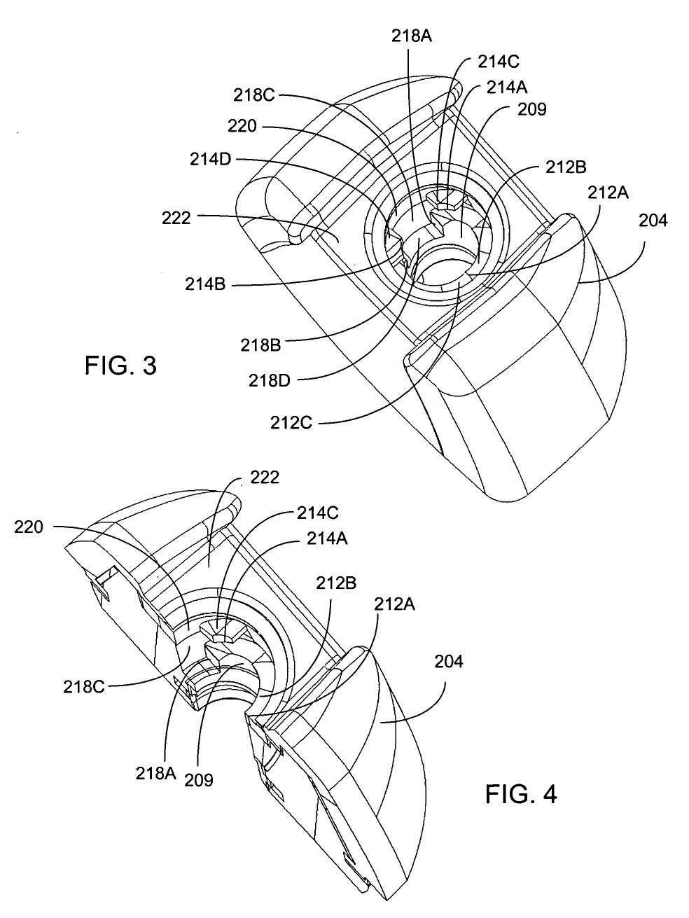

Referring now to FIG. 3, the components 212-222 of the housing assembly 204 are shown in accordance with an embodiment of the present invention. FIG. 4 illustrates a cross section of FIG. 3 for clearer viewing of the surfaces of the housing assembly 204. From illustrations of FIGS. 3 and 4, the housing assembly 204 comprises a conduit 209 for insertion and extraction of the stem 206, a cavity 222 above the conduit 209 shaped according to the irregular shaped head 202 for engaging therewith, and a guiding element 212 to rotationally guide the nipple 208 so that the irregular shaped head 202 aligns with the cavity 222 during insertion. The guiding element 212 can be a slide (herein referred to as slide 212) as shown in FIG. 3. Other forms of a guiding element 212 suitable to the present invention can be used in accordance with the claims described herein.

The slide 212 can have three surfaces. A first surface of the slide 212 is a peak 212A, which in the present embodiment has a sharp edge so as to cause the nipple 208 to slide in clockwise or counter-clockwise direction. Alternatively, the peak 212A can be a smooth surface with a surface area small enough to maintain the tendency in the nipple 208 to move rotationally according to an angle of engagement therewith. On each side of the peak 212A of the slide is a counter-clockwise declining slope 212B and a clockwise declining slope 212C that circles the conduit 209 and convenes at an end point. The rate of descent of the slopes 212B and 212C can be any range (e.g., 45 to 60 degrees) so long as it is suitable for producing a rotating effect on the nipple 208 while the antenna 102 components are being forced down into the conduit 209 by an external force such as an end user of the SCR 100. The slopes 212B and 212C can have a symmetrical or an asymmetrical rate of decline. Moreover, a portion of said surfaces 212B-212C of the slide 212 has an angular geometry relative to the conduit for rotationally guiding the nipple 208 to the end point.

The end point is represented in the embodiment of FIGS. 3 and 4 as a tunnel 218 having four surfaces 218A-218D. The tunnel 218 has opposing first and second surfaces 218A-218B coupled to the slide 212. The first and second surfaces 218A-218B are separated by a gap having a width greater than a size 205 (see FIG. 5) of the nipple 208. In this illustration, the nipple 208 is represented by a circular protrusion of the stem 206. It will be appreciated by one of ordinary skill in the art that other shapes can be used for the nipple 208 which are not rounded, while such shapes can remain operable in accordance with the invention as described herein. The first and second surfaces 218A-218B each have a declining slope that is greater than the counter-clockwise and clockwise declining slopes 212B-212C. For the present illustration, the declining slope of the first and second surfaces 218A-218B is ninety degrees steeper than the counter-clockwise and clockwise declining slopes 212B-212C. The tunnel 218 further has a third surface 218D cylindrically aligned to the conduit 209 and coupled to the first and second surfaces 218A-218B at ninety degrees, thereby forming a cavity 220 in the conduit 209. A fourth surface 218C coupled to the first, second and third surfaces of the tunnel 218A-218B serves as an end point of the tunnel 218.

As an alternative embodiment of the present invention, the end point of the slides 212 can be represented by a convergence point of the counter-clockwise and clockwise declining slopes 212B-212C thereby forming, for example, a “V” or “U” shaped juncture. Accordingly, as the nipple 208 slides down either of the declining slopes 212B-212C of the slide 212, it meets at the end point of the slide 212 as represented by any one of three embodiments: the “V” shaped, “U” shaped or tunnel 218 embodiments. Other shapes for the end point of the slide 212 suitable for the present invention can be used. When the nipple 208 reaches the end point of the slide 212, the irregular shaped head 202 of the antenna 102 aligns with the cavity 222 at zero degrees rotation 202B as shown in FIG. 2 for re-insertion in the home position 202A.

As a supplement to the foregoing embodiments of the present invention, the housing assembly 204 further includes a first protrusion 214 and a second protrusion coupled to a cavity 220 of the conduit 209, which are situated above the slide 212 with sufficient spacing to allow the nipple 208 to travel below said protrusions 214A-214B. The protrusions 214A-214B are separated by the gap described above for allowing the nipple 208 to traverse between them. In addition, the first and second protrusions 214A-214B have protrusion slides 214C-214D with declining slopes. Any suitable rate of decline (e.g., 60 degrees) can be used for these slopes so long as it is sufficient to cause the nipple 208 to slide on said protrusion slides 214C-214D towards the gap.

There are three possible functions for the protrusions 214A-214B depending on the position of the nipple 208. A first case involves the nipple 208 aligned with the tunnel 218 during insertion of the antenna 102. In this instance, the nipple 208 travels downward between the protrusions 214A-214B and into the tunnel 218. In this example, the irregular shaped head 202 of the antenna 102 aligns with the cavity 222 and no significant rotations occur during insertion.

A second case involves the nipple 208 positioned away from the protrusions 214A-214B during insertion with a probable engagement with either the peak 212A or either of the counter-clockwise or clockwise declining slopes 212B-212C of the slide 212. In this instance, the nipple 208 travels down the slide 212 eventually passing below either protrusion 214A-214B and moving abruptly down the tunnel 218 when it reaches the end point of the slide 212. During this insertion process, the protrusions 214A-214B are also serving to guide the stem 206 in alignment with the conduit 209 to avoid a bend in the stem 206 that might cause the nipple 208 to disengage with the slide 212.

A third case involves the nipple 208 engaging with either protrusion slide 214C-214D. In this case, the nipple 208 slides on one of the protrusion slides 214C-214D towards the tunnel 218 thereby causing an abrupt downward motion during insertion of the stem 206. In each of the foregoing cases, the nipple 208 is directed to the tunnel 218, thereby aligning the irregular shaped head 202 of the antenna 102 with the cavity 222.

FIG. 6 provides a final illustration of the process for engaging the antenna 102 with the housing assembly 204 in accordance with the present invention. In this illustration, the nipple 208 engages with the clockwise declining slope 212C of the slide 212 during insertion providing rotational alignment of the irregular shaped head 202 of the antenna 102 with the cavity 222 once it reaches the home position 202A.

In light of the foregoing description, it should be evident that embodiments in the present invention could be realized in numerous configurations contemplated to be within the scope and spirit of the claims below. It should also be understood that the claims are intended to cover the structures described herein as performing the recited function and not only structural equivalents. For example, although a nail and a screw fastener may not be structural equivalents in that the nail has no spiral threading, a nail and a screw fastener can be used for securing objects firmly together, thereby making the nail and screw fastener equivalent structures. Accordingly, equivalent structures that read on the description provided herein are intended to be included within the scope of the invention as defined in the following claims.

What is claimed is:

1. An apparatus, comprising:
an irregular shaped head coupled to a top end of a stem;
a nipple coupled to a side surface of the stem; and
a housing assembly comprising:
a conduit for insertion and extraction of the stem;
a cavity above the conduit, wherein the cavity is shaped according to the irregular shaped head for engaging therewith; and
a slide coupled to the conduit to rotationally guide the nipple so that the irregular shaped head aligns with the cavity during insertion.

2. The apparatus of claim 1, wherein the slide has a peak, and wherein from the peak the slide has a clockwise declining slope and a counter-clockwise declining slope around the conduit that convene at an end point.

3. The apparatus of claim 2, wherein the clockwise declining slope and the counter-clockwise declining slope have a symmetrical rate of decline.

4. The apparatus of claim 2, wherein the clockwise declining slope and the counter-clockwise declining slope have an asymmetrical rate of decline.

5. The apparatus of claim 2, wherein the end point convenes with a tunnel having opposing first and second surfaces coupled to the slide, wherein the first and second surfaces are separated by a gap greater than a size of the nipple, and wherein the first and second surfaces each have a declining slope greater than the clockwise and counter-clockwise declining slopes.

6. The apparatus of claim 5, wherein a third surface of the tunnel is a cavity of the conduit.

7. The apparatus of claim 5, wherein the tunnel has an end point having a fourth surface.

8. The apparatus of claim 2, wherein a portion of a surface of the slide has an angular geometry for rotationally guiding the nipple.

9. The apparatus of claim 5, further comprising a first protrusion and a second protrusion coupled to a cavity of the conduit, wherein the first and second protrusions are situated above the slide with sufficient spacing to allow the nipple to travel below said protrusions, and wherein said protrusions are separated by the gap for allowing the nipple to traverse between them.

10. The apparatus of claim 9, wherein the first protrusion and second protrusion each have a protrusion slide, and wherein each protrusion slide has a declining slope to guide the nipple to the gap when said nipple engages therewith.

11. The apparatus of claim 1, wherein the irregular shaped head and stem comprise an antenna coupled to an electrical circuit for processing radio signals.

12. A selective call radio (SCR), comprising:
an antenna comprising an irregular shaped head coupled to a top end of a stem having a nipple coupled to a side surface of the stem;
a receiver coupled to the antenna;
a processor coupled to the receiver; and
a housing assembly comprising:
a conduit for insertion and extraction of the stem;
a cavity above the conduit, wherein the cavity is shaped according to the irregular shaped head for engaging therewith; and
a slide coupled to the conduit to rotationally guide the nipple so that the irregular shaped head aligns with the cavity during insertion.

13. The SCR of claim 12, wherein the slide has a peak, and wherein from the peak the slide has a clockwise declining slope and a counter-clockwise declining slope around the conduit that convene at an end point.

14. The SCR of claim 12, wherein the end point convenes with a tunnel having opposing first and second surfaces coupled to the slide, wherein the first and second surfaces are separated by a gap greater than a size of the nipple, and wherein the first and second surfaces each have a declining slope greater than the clockwise and counter-clockwise declining slopes.

15. The SCR of claim 14, further comprising a first protrusion and a second protrusion coupled to a cavity of the conduit, wherein the first and second protrusions are situated above the slide with sufficient spacing to allow the nipple to travel below said protrusions, wherein said protrusions are separated by the gap for allowing the nipple to traverse between them, wherein the first protrusion and second protrusion each have a protrusion slide, and wherein each protrusion slide has a declining slope to guide the nipple to the gap when said nipple engages therewith.

16. An apparatus, comprising:
an irregular shaped head coupled to a top end of a stem;
a protrusion coupled to a side surface of the stem; and
a housing assembly comprising:
a conduit for insertion and extraction of the stem;
a cavity above the conduit, wherein the cavity is shaped according to the irregular shaped head for engaging therewith; and
a guiding element coupled to the conduit to rotationally guide the protrusion of the stem so that the irregular shaped head aligns with the cavity during insertion.

17. The apparatus of claim 16, wherein the guiding element has a peak, and wherein from the peak the guiding element has a clockwise declining slope and a counter-clockwise declining slope around the conduit that convene at an end point.

18. The apparatus of claim 17, wherein the end point convenes with a tunnel having opposing first and second surfaces coupled to the guiding element, wherein the first and second surfaces are separated by a gap greater than a size of the protrusion of the stem, and wherein the first and second surfaces each have a declining slope greater than the clockwise and counter-clockwise declining slopes.

19. The apparatus of claim 18, further comprising a first protrusion and a second protrusion coupled to a cavity of the conduit, wherein the first and second protrusions are situated above the guiding element with sufficient spacing to allow the protrusion of the stem to travel below said protrusions, and wherein said protrusions are separated by the gap for allowing the protrusion of the stem to traverse between them.

20. The apparatus of claim 19, wherein the first protrusion and second protrusion each have a protrusion slide, and wherein each protrusion slide has a declining slope to guide the protrusion of the stem to the gap when said protrusion engages with either of the first and second protrusion slides.
